(19) United States
(12) Patent Application Publication
(10) Pub. No.: US 2022/0191132 A1
(43) Pub. Date: Jun. 16, 2022

(54) METHOD FOR REESTABLISHING LABEL SWITCHED PATH, AND NETWORK APPARATUS

(71) Applicant: Telefonaktiebolaget LM Ericsson (publ), Stockholm (SE)

(72) Inventors: Yuting LIU, Beijing (CN); Mingliang HUANG, Beijing (CN); Jiangang QI, Beijing (CN)

(21) Appl. No.: 17/435,865

(22) PCT Filed: Mar. 7, 2019
(86) PCT No.: PCT/CN2019/077315

§ 371 Date: Sep. 2, 2021

(51) Int. Cl. H04L 45/28; H04L 41/0668; H04L 41/0816; H04L 41/12; H04L 45/00; H04L 45/50

(52) U.S. Cl. CPC H04L 45/28; H04L 41/0668; H04L 45/507; H04L 41/12; H04L 45/22; H04L 41/0816

(57) ABSTRACT

The present disclosure relates to a method for reestablishing a label switched path, LSP, and a network apparatus. The method is performed at a network apparatus and includes: detecting a breakage of a label distribution protocol, LDP, session between the network apparatus and a first downstream network apparatus in which the first downstream network apparatus is in a first label switched path, LSP, from the network apparatus to a destination network apparatus; calculating a second LSP from the network apparatus to the destination network apparatus, by using a constrained shortest path first, CSPF, algorithm; and replacing the first LSP with the second LSP. A LSP broke broken due to a breakage of a LDP session may be reestablished easier and quicker using the arrangements described herein.

### TECHNICAL FIELD

The present disclosure relates generally to the technology of network, and in particular, to a method for reestablishing a label switched path, LSP, and a network apparatus.

### BACKGROUND

This section introduces aspects that may facilitate better understanding of the present disclosure. Accordingly, the statements of this section are to be read in this light and are not to be understood as admissions about what is in the prior art or what is not in the prior art.

In Multiprotocol Label Switching (MPLS) network deployment, usually the Label Distribution Protocol (LDP) is adopted to distribute labels among network apparatuses in the network, so as to establish Label Switched Path (LSP).

However, for such applications, it is not possible for the network to reply on internet protocol (IP) forwarding normally if MPLS LSP is not operational appropriately. For example, blackholing of labeled traffic can occur in situations where Interior Gateway Protocol (IGP) is operational on a link while LDP is not.

### SUMMARY

Certain aspects of the present disclosure and their embodiments may provide solutions to these or other challenges. There are, proposed herein, various embodiments which address one or more of the issues disclosed herein.

A first aspect of the present disclosure provides a method performed at a network apparatus, comprising: detecting a breakage of a label distribution protocol, LDP, session between the network apparatus and a first downstream network apparatus; wherein the first downstream network apparatus is in a first label switched path, LSP, from the network apparatus to a destination network apparatus; calculating a second LSP from the network apparatus to the destination network apparatus, by using a constrained shortest path first, CSPF, algorithm; and replacing the first LSP with the second LSP.

In embodiments of the present disclosure, the method further comprises: receiving a LDP label of a second downstream network apparatus in the second LSP, for a next label switching hop, LSH, of the network apparatus.

In embodiments of the present disclosure, the method further comprises: sending a LDP label request message to the second downstream network apparatus.

In embodiments of the present disclosure, the breakage of the LDP session is detected, by using a bidirectional forwarding detection, BFD, or a LDP keep-alive message.

In embodiments of the present disclosure, the network apparatus comprises: a router.

A second aspect of the present disclosure provides a network apparatus, comprising: a processor; and a memory, containing instructions executable by the processor; wherein the network apparatus is operative to: detect a breakage of a label distribution protocol, LDP, session between the network apparatus and a first downstream network apparatus; wherein the first downstream network apparatus is in a first label switched path, LSP, from the network apparatus to a destination network apparatus; calculate a second LSP from the network apparatus to the destination network apparatus, by using a constrained shortest path first, CSPF, algorithm; and replace the first LSP with the second LSP.

In embodiments of the present disclosure, the network apparatus is further operative to implement the method above mentioned.

A third aspect of the present disclosure provides a network apparatus, comprising: a detection unit, configured to detect a breakage of a label distribution protocol, LDP, session between the network apparatus and a first downstream network apparatus; wherein the first downstream network apparatus is in a first label switched path, LSP, from the network apparatus to a destination network apparatus; a calculation unit, configured to calculate a second LSP from the network apparatus to the destination network apparatus, by using a constrained shortest path first, CSPF, algorithm; and a replacement unit, configured to replace the first LSP with the second LSP.

In embodiments of the present disclosure, the network apparatus further comprises: a reception unit, configured to receive a LDP label of the second downstream network apparatus in the second LSP, for a next label switching hop, LSH, of the network apparatus.

In embodiments of the present disclosure, the network apparatus further comprises: a sending unit, configured to send a LDP label request message to the second downstream network apparatus.

In embodiments of the present disclosure, the detection unit is configured to detect the breakage of the LDP session, by using a bidirectional forwarding detection, BFD, or a LDP keep-alive message.

In embodiments of the present disclosure, the network apparatus comprises: a router.

A fourth aspect of the present disclosure provides a computer readable storage medium having a computer program stored thereon, the computer program executable by a device to cause the device to carry out the method above mentioned.

### BRIEF DESCRIPTION OF DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 is an exemplary block diagram showing a network, in which a method according to embodiments of the present disclosure is implemented;

FIG. 2 is an exemplary flow chart showing a method for reestablishing a label switched path, LSP, according to embodiments of the present disclosure;

FIG. 3 is an exemplary flow chart showing other steps of method as shown in FIG. 2;

FIG. 4 is a block diagram showing a network apparatus in accordance with embodiments of the present disclosure;

FIG. 5 is a block diagram showing function units of a network apparatus in accordance with embodiments of the present disclosure;

FIG. 6 is a block diagram showing a computer readable storage medium in accordance with embodiments of the present disclosure.

FIG. 7 is an exemplary flow chart showing a specific method performed in the network apparatus in accordance with embodiments of the present disclosure;

FIG. 8 is an exemplary flow chart showing other exemplary steps of the method as shown in FIG. 7.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network”, or “communication network/system” refers to a network/system following any suitable communication standards, such as new radio (NR), long term evolution (LTE), LTE-Advanced, wideband code division multiple access (WCDMA), high-speed packet access (HSPA), Internet, Local Area Network (LAN), Wide Area Network (WAN), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future, and/or further protocols, such as internet protocol (IP).

The term “apparatus” herein may refer to any end device that can access a communication network and receive services therefrom.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As an example, in certain networks, there is dependency on edge-to-edge LSP set up by LDP, e.g., MPLS Virtual Private Network (VPN) network. In practical network deployment, there could be situations that IGP is operational while LDP is not. E.g., due to configuration fault, or during network node/apparatus reboot process. This situation is especially hazardous in MPLS VPN core network. If such issue occurs, outer LDP label will be popped and inner VPN label will be exposed to P node, therefore VPN traffic is blackholed.

LDP IGP Synchronization mechanism is introduced to address the issue that Interior Gateway Protocol (IGP) is operational on a link while LDP is not.

Technical documents, such as 2 Request for Comments (RFCs) (RFC5443 and RFC6138) give examples about this LDP IGP Synchronization mechanism. RFC5443 would like to solve the problem above in peer to peer (P2P) network, and broadcast network with only one LDP/IGP peer. RFC6138 would like to cover the scenario of broadcast networks with more than one LDP/IGP peer.

Specifically, RFC5443 provides a way to establish communication between LDP and IGP. IGP can “know” LDP session operational status via its LDP IGP sync mechanism. When the LDP session down with one peer on the broadcast network, and its cost is changed to maximum value (for example, 65535), it will potentially affect LDP sessions with other peers. In other case, when a new router is discovered on a broadcast network, that network should avoid transit traffic until LDP becomes operational between all routers on that network.

RFC5443 could work well in P2P link and broadcast link with only one LDP/IGP peer. But it has limitation on broadcast network with more than one LDP/IGP peer.

In order to address RFC5443 limitation on broadcast network, RFC6138 proposes another solution. When IGP is operational and LDP session is not, instead of manipulating interface metric, It will remove the link that is coming up or LDP is down from the Link State DataBase (LSDB) unless absolutely necessary.

However, RFC6138 doesn't provide a clear calculation algorithm. It is hard to implement in practice without concrete design. Further, it needs to trigger recalculation in case of any topology change in the whole network.

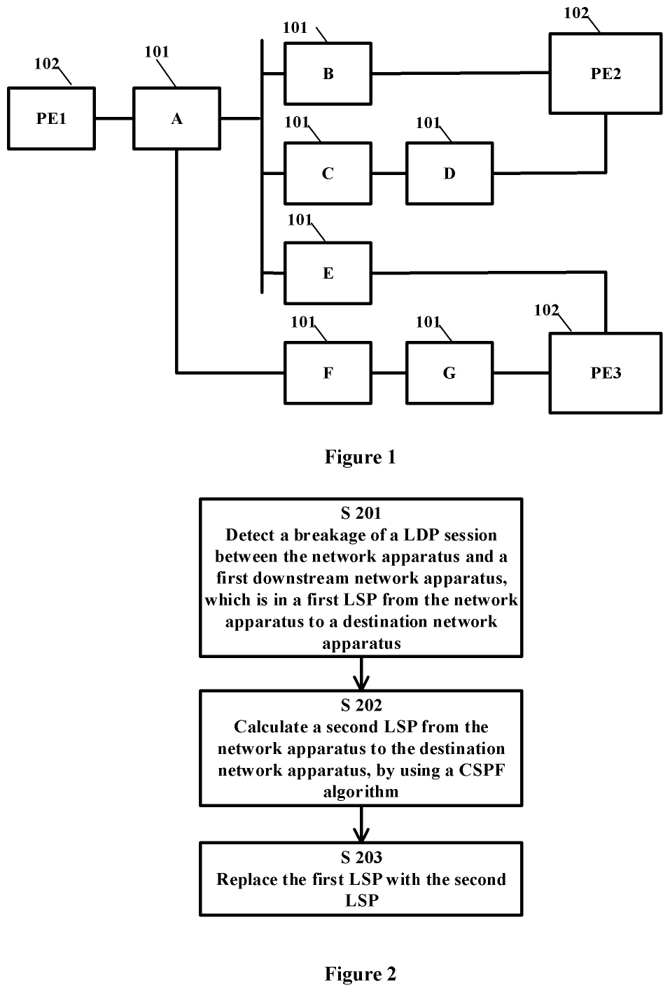

FIG. 1 is an exemplary block diagram showing a network, in which a method according to embodiments of the present disclosure is implemented. As shown in FIG. 1,

A network including a plurality of network apparatuses is shown in FIG. 1. As an example, these network apparatuses includes Label Switched Routers (LSR) 101, and Provider Edge (PE) 102. This may be one of broadcast network deployment topology. The metric on all links may be 1. The two existing LSPs may be PE1-A-B-PE2, PE1-A-E-PE3.

The embodiment of the present disclosure may provide a method for reestablishing a label switched path, if any one of the existing LSPs is down.

FIG. 2 is an exemplary flow chart showing a method for reestablishing a label switched path, LSP, according to embodiments of the present disclosure.

As shown in FIG. 2, the method performed at a network apparatus comprises: step S201, detecting a breakage of a label distribution protocol, LDP, session between the network apparatus and a first downstream network apparatus; wherein the first downstream network apparatus is in a first label switched path, LSP, from the network apparatus to a destination network apparatus; step S202, calculating a second LSP from the network apparatus to the destination network apparatus, by using a constrained shortest path first, CSPF, algorithm; and step S203, replacing the first LSP with the second LSP.

According to embodiments of the present disclosure, if a first LSP is broke due to a breakage of a LDP session between the network apparatus and a first downstream network apparatus, a second LSP from the network apparatus to the destination network apparatus is calculated by the CSPF algorithm. The LSP from the network apparatus to the destination network apparatus may be reestablished easily and quickly, and the dependency of LSP and IGP routing information is reduced. Namely, only the information for the CSPF algorithm is needed.

See FIG. 1, as an example, when the LSR A wants to transfer data to the PE2 via the LDP PE1-A-B-PE2, the LSR A finds that the LSP/LSP part A-B-PE2 is down due to that the LDP session between LSR A and LSR B is down. Then, the CSPF algorithm may calculate a new LSP/LSP part A-C-D-PE2, so as to replace the LSP/LSP part A-B-PE2. Namely, the PE1-A-B-PE2 may be replaced by PE1-A-C-D-PE2.

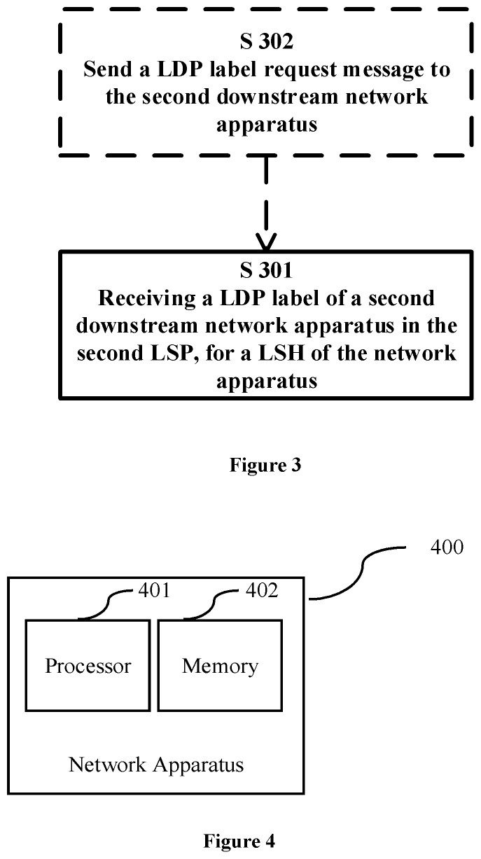

FIG. 3 is an exemplary flow chart showing other steps of method as shown in FIG. 2.

As shown in FIG. 3, the method further comprises: step S301, receiving a LDP label of a second downstream network apparatus in the second LSP, for a next label switching hop, LSH, of the network apparatus.

After the new LSP PE1-A-C-D-PE2 is determined, the LSR A restarts the data transmission, and the LSR A needs the label of the LSR C.

For example, if the operation configuration about the label retention in the network is “liberal mode”, in which the LSR C may send its label to LSR A initiatively and the LSR A will store this label, the step S301 is directly implemented.

Additionally, the method may further comprises: step S302, sending a LDP label request message to the second downstream network apparatus. Namely, in other mode, such as a “conservative mode”, LSR A would not receive and store the label of the LSR C unless LSR A sends a LDP label request message and receives a response from the LSR C.

In embodiments of the present disclosure, the breakage of the LDP session is detected, by using a bidirectional forwarding detection, BFD, or a LDP keep-alive message. The specific manner to detect the breakage of the LDP session is not limited, and as examples, BFD, or a LDP keep-alive message may be applied.

In embodiments of the present disclosure, the network apparatus comprises: a router. Although the LSR A as shown in FIG. 1 is provided as an example, the network apparatus is not limited to such LSR 110. Any network apparatus with router function, such as PE 102, may also be applied.

FIG. 4 is a block diagram showing a network apparatus in accordance with embodiments of the present disclosure.

The network apparatus 400 may comprise: a processor 401; and a memory 402, containing instructions executable by the processor 401. The network apparatus 400 is operative to: detect a breakage of a label distribution protocol, LDP, session between the network apparatus and a first downstream network apparatus; wherein the first downstream network apparatus is in a first label switched path, LSP, from the network apparatus to a destination network apparatus; calculate a second LSP from the network apparatus to the destination network apparatus, by using a constrained shortest path first, CSPF, algorithm; and replace the first LSP with the second LSP.

In embodiments of the present disclosure, the network apparatus 400 is further operative to implement any method above mentioned. For example, the network apparatus 400 may further receive a LDP label of a second downstream network apparatus in the second LSP, for a next label switching hop, LSH, of the network apparatus. The network apparatus 400 may further send a LDP label request message to the second downstream network apparatus.

According to embodiments of the present disclosure, if a first LSP is broke due to a breakage of a LDP session between the network apparatus and a first downstream network apparatus, a second LSP from the network apparatus to the destination network apparatus is calculated by the CSPF algorithm. The LSP from the network apparatus to the destination network apparatus may be reestablished easily and quickly, and the dependency of LSP and IGP routing information is reduced. Namely, only the information for the CSPF algorithm is needed.

The processor 401 may be any kind of processing component, such as one or more microprocessor or microcontrollers, as well as other digital hardware, which may include digital signal processors (DSPs), special-purpose digital logic, and the like. The memory 402 may be any kind of storage component, such as read-only memory (ROM), random-access memory, cache memory, flash memory devices, optical storage devices, etc.

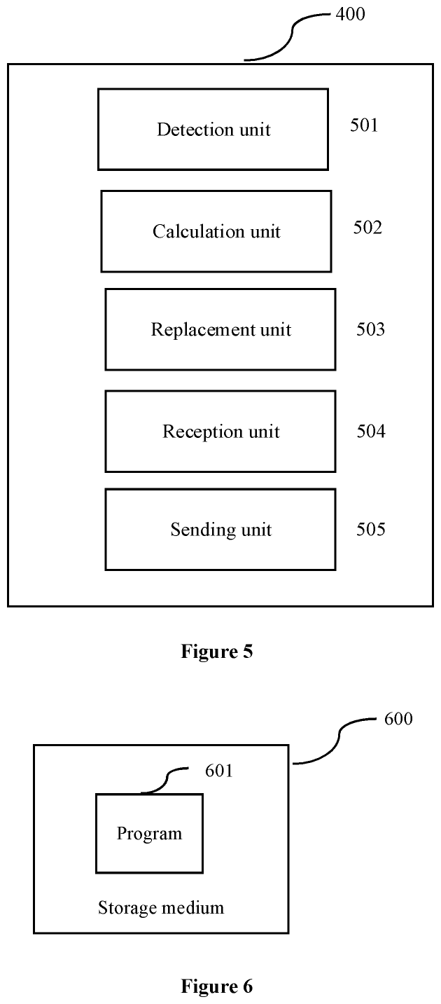

FIG. 5 is a block diagram showing function units of a network apparatus in accordance with embodiments of the present disclosure.

As shown in FIG. 5, the network apparatus 400 comprises: a detection unit 501, configured to detect a breakage of a label distribution protocol, LDP, session between the network apparatus and a first downstream network apparatus; wherein the first downstream network apparatus is in a first label switched path, LSP, from the network apparatus to a destination network apparatus; a calculation unit 502, configured to calculate a second LSP from the network apparatus to the destination network apparatus, by using a constrained shortest path first, CSPF, algorithm; and a replacement unit 503, configured to replace the first LSP with the second LSP.

In embodiments of the present disclosure, the network apparatus further comprises: a reception unit 504, configured to receive a LDP label of the second downstream network apparatus in the second LSP, for a next label switching hop, LSH, of the network apparatus.

In embodiments of the present disclosure, the network apparatus further comprises: a sending unit 505, configured to send a LDP label request message to the second downstream network apparatus.

These function unit may have conventional arrangement in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With separated function units, the network apparatus 400 may not need a fixed processor or memory, any computing resource and storage resource may be arranged from at least one network devices. The introduction of virtualization technology and network computing technology will be easier, and may improve the usage efficiency of the network resources and the flexibility of the network.

FIG. 6 is a block diagram showing a computer readable storage medium in accordance with embodiments of the present disclosure.

As shown in FIG. 6, the computer readable storage medium 600 having a computer program 601 stored thereon, the computer program 601 may be executable by a device to cause the device to carry out the method above mentioned.

For example, the computer program 601 may be executable by the LSR A to implement methods shown in FIGS. 2 and 3.

The computer readable storage medium 600 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives.

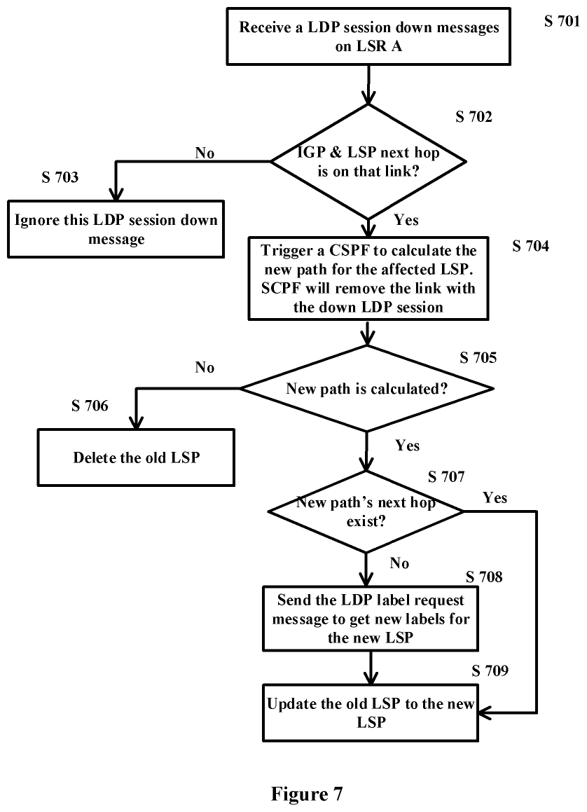

FIG. 7 is an exemplary flow chart showing a specific method performed in the network apparatus in accordance with embodiments of the present disclosure;

As shown in FIG. 7, a more specific method than that shown in FIG. 2 or 3 is illustrated, so as to be easier for a processor to implement. However, this is also not a limitation, the method in FIG. 2 or 3 may be specified in any other manner.

In step S701, the LSR A may receive a LDP session down message. In step S702, it is determined whether a (IGP&LSP) next hop is on that link. If the determination is no in S702, the step S703 is executed, and this LDP session down message is ignored. For example, if the current complete LDP is PE1-A-B-PE2, the LSR A will ignore a LDP session down message from LSR C, or E. If the determination is yes in S702, the step S704 is executed, and a CSPF is triggered to calculate the new path for the affected LSP. SCPF will remove the link with the down LSP session. For example, if the current complete LSP is PE1-A-B-PE2, a LDP session down message from LSR B to LSR A will trigger a CSPF to calculate the new path, and the CSPF will remove the LDP session between LSR A and LSR B. In step S705, it is determined whether the new path is calculated. If it is no in S705, the old LSP is deleted directly in step S706. If it is yes (for example, “A-C-D-PE2” may be calculated) in S705, it is further determined whether new path's next hop exist in step S707. Namely, the LSR A may check whether a label of the LSR C, or any other LSR in the new path, is stored. If it is yes in step S707, the old LSP “A-B-PE2” is updated to “A-C-D-PE2” in step S709. Otherwise, the LSR A may send the LDP label request message to get new labels for the new LSP in step S708, and then the old LSP “A-B-PE2” is updated to “A-C-D-PE2” in step S709.

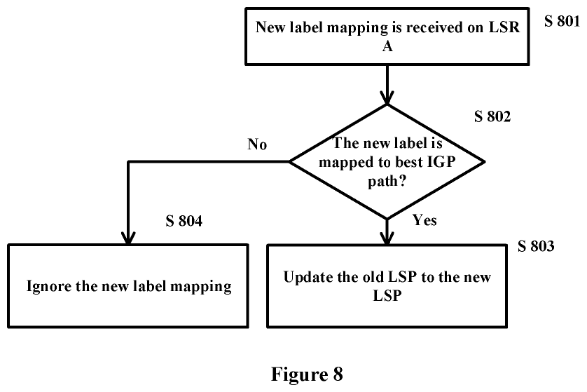

FIG. 8 is an exemplary flow chart showing other exemplary steps of the method as shown in FIG. 7.

As shown in FIG. 8, when LSR A (as shown in FIG. 1) receives new label mapping message in step S801, it is determined whether the new label is mapped to best IGP path in step S802. If it is yes in step S602, an old LSP may be updated to a new LSP with new label mapping in step S803. If it is no in step S802, the new label mapping is ignored in step S804. As examples, new label mapping will occur in either condition of: (1) the down LDP session becomes up; (2) LDP is converged after IGP is converged in new router adding scenario.

For example of (1), when the down LDP session between LSR A and LSR B becomes up, if label of B is mapped to the best IGP path, the old LSP “A-C-D-PE2” is updated to “A-B-PE2” again. The example of (2) will be similar.

According to embodiments of the present disclosure, if a first LSP is broke due to a breakage of a LDP session between the network apparatus and a first downstream network apparatus, a second LSP from the network apparatus to the destination network apparatus is calculated by the CSPF algorithm. The LSP from the network apparatus to the destination network apparatus may be reestablished easily and quickly, and the dependency of LSP and IGP routing information is reduced. Namely, only the information for the CSPF algorithm is needed.

In general, the various exemplary embodiments of the present disclosure may be implemented in hardware or special purpose circuits, software, logic or any combination thereof. For example, some aspects may be implemented in hardware, while other aspects may be implemented in firmware or software that may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may include circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed at a network apparatus, the method comprising:
detecting a breakage of a label distribution protocol, LDP, session between the network apparatus and a first downstream network apparatus, the first downstream network apparatus being in a first label switched path, LSP, from the network apparatus to a destination network apparatus;
calculating a second LSP from the network apparatus to the destination network apparatus, by using a constrained shortest path first, CSPF, algorithm; and
replacing the first LSP with the second LSP.

2. The method according to claim 1, further comprising:
receiving a LDP label of a second downstream network apparatus in the second LSP, for a next label switching hop, LSH, of the network apparatus.

3. The method according to claim 2, further comprising:
sending a LDP label request message to the second downstream network apparatus.

4. The method according to claim 1, wherein the breakage of the LDP session is detected one of by using a bidirectional forwarding detection, BFD, and a LDP keep-alive message.

5. The method according to claim 1, wherein the network apparatus comprises a router.

6. A network apparatus, comprising:
a processor; and
a memory containing instructions executable by the processor; and
the memory and the processor configuring the network apparatus to:
detect a breakage of a label distribution protocol, LDP, session between the network apparatus and a first downstream network apparatus, the first downstream network apparatus being in a first label switched path, LSP, from the network apparatus to a destination network apparatus;
calculate a second LSP from the network apparatus to the destination network apparatus, by using a constrained shortest path first, CSPF, algorithm; and
replace the first LSP with the second LSP.

7. (canceled)

8. (canceled)

9. The network apparatus according to claim 6, wherein the memory and the processor further configure the network apparatus to:
receive a LDP label of the second downstream network apparatus in the second LSP, for a next label switching hop, LSH, of the network apparatus.

10. The network apparatus according to claim 9, wherein the memory and the processor further configure the network apparatus to:
send a LDP label request message to the second downstream network apparatus.

11. The network apparatus according to claim 8, wherein the breakage of the LDP session is detected by using one of a bidirectional forwarding detection, BFD, and a LDP keep-alive message.

12. The network apparatus according to claim 8, wherein the network apparatus is a router.

13. A computer readable storage medium having a computer program stored thereon, the computer program executable by a device to cause the device to:
detect a breakage of a label distribution protocol, LDP, session between the network apparatus and a first downstream network apparatus, the first downstream network apparatus being in a first label switched path, LSP, from the network apparatus to a destination network apparatus;
calculate a second LSP from the network apparatus to the destination network apparatus, by using a constrained shortest path first, CSPF, algorithm; and
replace the first LSP with the second LSP.

14. The method according to claim 2, wherein the breakage of the LDP session is detected one of by using a bidirectional forwarding detection, BFD, and a LDP keep-alive message.

15. The method according to claim 14, wherein the network apparatus comprises a router.

16. The method according to claim 2, wherein the network apparatus comprises a router.

17. The method according to claim 3, wherein the breakage of the LDP session is detected one of by using a bidirectional forwarding detection, BFD, and a LDP keep-alive message.

18. The network apparatus according to claim 9, wherein the wherein the breakage of the LDP session is detected by using one of a bidirectional forwarding detection, BFD, and a LDP keep-alive message.

19. The network apparatus according to claim 18, wherein the network apparatus is a router.

20. The network apparatus according to claim 9, wherein the network apparatus is a router.

21. The network apparatus according to claim 20, wherein the breakage of the LDP session is detected by using one of a bidirectional forwarding detection, BFD, and a LDP keep-alive message.

22. The network apparatus according to claim 10, wherein the breakage of the LDP session is detected by using one of a bidirectional forwarding detection, BFD, and a LDP keep-alive message.
